(19) United States
(12) Patent Application Publication
(10) Pub. No.: US 2010/0050653 A1
(43) Pub. Date: Mar. 4, 2010

(54) COMBUSTOR SYSTEM AND METHOD OF REDUCING COMBUSTION INSTABILITY AND/OR EMISSIONS OF A COMBUSTOR SYSTEM

(76) Inventor: Kam-Kei Lam, Bracebridge Health (GB)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/547,858

(22) Filed: Aug. 26, 2009

(30) Foreign Application Priority Data
Sep. 4, 2008 (EP) EP08015646

(51) Int. Cl. F02C 9/26; F02C 7/22; F02C 7/14

(52) U.S. Cl. 60/772; 60/734; 431/12; 431/75

(57) ABSTRACT

A combustor system including a combustion chamber and at least one burner connected to the combustion chamber is provided. The combustion chamber includes a flow entrance which connects the burner to the combustion chamber, a flow exit through which combustion gases exit the combustion chamber, a chamber volume which extends between the flow entrance and the flow exit, and an inner chamber wall separating a cooling fluid channel from the chamber volume. A fuel supply line is present in the cooling fluid channel for supplying fuel to the cooling fluid. A method for reducing combustion instability and/or emissions of a combustor system is also provided.

### CROSS REFERENCE TO RELATED APPLICATIONS

This application claims priority of European Patent Office application No. 08015646.6 EP filed Sep. 4, 2008, which is incorporated by reference herein in its entirety.

### FIELD OF INVENTION

The present invention relates to a combustor system comprising a combustion chamber and at least one burner. The invention further relates to a method of reducing combustion instability and/or emissions of a combustor system.

### BACKGROUND OF INVENTION

Within the world wide effort to reduce emissions in exhaust gases of gas turbines one aims to reduce in particular the NOx emissions. The NOx emission in a gas turbine is exponentially proportional to the highest temperature in the combustor. Modern premix low NOx burners achieve a low NOx-emission by lean fuel-air mixtures in which fuel and air are evenly mixed in order to make the chemical reaction temperature more homogeneous and in order to avoid local fuel rich hot spots.

Although these measures are already successfully applied there is still room for improvements in low NOx emission combustion systems, in particular of gas turbine combustion systems. For example, lean fuel-air mixtures can lead to flame instabilities due to the relatively small fraction of fuel in the fuel air mixture. Such flame instabilities can cause combustion dynamic pressure waves which reduce life time of a combustion system and which may be amplified if combustion dynamic pressure waves are in phase with fuel injection fluctuations. In the end, an amplification of combustion dynamic pressure waves may damage the combustion system.

Moreover, in gas turbines, burner flow aerodynamics and mixing behaviour varies at different loads and influences the emissions. In US 2001/004827 premix fuel staging has been proposed to reduce emissions at reduced loads of a gas turbine.

### SUMMARY OF INVENTION

With respect to the above it is an objective of the present invention to provide an improved combustor system comprising combustion chamber and at least one burner. It is a further objective of the present invention to provide a method of reducing combustion instability and/or emissions of a combustor system.

These objectives are solved by combustor system as claimed in the claims and by method of reducing combustion instabilities/or emissions as claimed in the claims.

An inventive combustor system comprises a combustion chamber and at least one burner connected to the combustion chamber. The combustion chamber includes a flow entrance by which the burner is connected to the combustion chamber and a flow exit through which the combustion gas exits the combustion chamber. A chamber volume extends between the flow entrance and the flow exit and is separated from a cooling fluid channel by an inner chamber wall. In the inventive combustor system, a fuel supply is present in the cooling fluid channel for supplying fuel to the cooling fluid.

Introducing fuel into the cooling channel of a combustor system allows for a new method of staging premixed fuel. The fuel introduced into the cooling fluid channel mixes with the cooling fluid, usually compressor air. The generated fuel air mixture can then be introduced into the burner if the cooling channel belongs to a regenerative cooling system, i.e. to a cooling system in which the cooling air for cooling a combustion chamber is led to a burner an there used for the combustion process. Alternatively, the fuel-air mixture in the cooling channel can be introduced directly into the combustion chamber, e.g. by effusion holes. The latter process can be used for stabilising recirculation zones in a combustion chamber.

The combustor system may further comprise an outer chamber wall which surrounds the inner chamber wall and which comprises through holes connecting the cooling fluid channel to a pressure plenum with cooling fluid such that the cooling fluid impinges onto the inner chamber wall. An impinging cooling fluid generates a high intensity of turbulences through the impingement jets, which promotes premixing of the fuel and the cooling fluid, usually air, in the cooling channel. Other possible means for enhancing turbulences and premixing fuel and air in the cooling channel are, for example, fins, turbulators, flow contraction and expansion means in the air inlet and outlet. Those means may alternatively or additionally to the impingement jets be present. A high intensity of turbulence and the thus promoted premixing of fuel and air is beneficial for archiving low NOX emissions.

A fuel split control system may be present for controlling the distribution of fuel to the burner and to the cooling fluid channel. Such a fuel split control system may include individual fuel supply lines for the at least one burner and the cooling fluid channel where each individual fluid supply line is equipped with a control valves. Due to the different lengths the fuel has to travel different time lags of the fuel stages, i.e. the fuel introduced directly into the burner and the fuel introduced into the cooling fluid channel, are present which allow to reduce fuel injection fluctuations that are in phase with combustion dynamic pressure waves by allowing the fuel of both stages to arrive at the flame at different times. By carefully setting the fuel split to the longer time lag of the cooling channel injection and the shorter time lag of the fuel injection into the burner can therefore be used to effectively avoiding the above mentioned amplifying loop and, hence, combustion instabilities.

To determine a fuel split which effectively reduces the amplification of pressure waves the fuel split control system may include a combustion dynamics sensor, e.g., a pressure sensor measuring the pressure in the combustion chamber or an acceleration sensor measuring the acceleration of the combustion chamber wall, and/or NOx sensor measuring the NOx fraction in the combustion gases. A controller is then connected to the combustion dynamics sensor and/or the NOx sensor for receiving sensor signals representing the measured combustion dynamics and/or the measured NOx amount, respectively. The controller is designed for deriving a fuel split signal representing the fuel split to be set by the fuel split control system on the bases of the measured combustion dynamics and/or the measured NOx amount. This allows for building a feedback loop for effectively reducing combustion dynamics and NOx emissions.

The controller of the control system or a further controller may control the fuel supply to the cooling fluid in the cooling fluid channel such that the amount of fuel supplied to the cooling fluid is so low that the resulting fuel air mixture is below flammability limit. This prevents the fuel air mixture from inflaming in the cooling fluid channel.

In a special embodiment of the inventive combustor system the fuel supply is located near the flow exit of the combustion chamber and the cooling fluid channel is in flow connection with the burner. In other words, this embodiment resembles a regenerative cooling system as mentioned above. In the system the time lag between the fuel reaching the burner directly and the fuel reaching the burner via the cooling fluid channel can be made very long. In addition, due to the long path of the fuel-air mixture through the cooling channel along the hot inner combustor wall the premixed fuel is naturally preheated when flowing to the burner. This leads to increased combustion efficiency.

In a second special embodiment of the inventive combustor system the inner chamber wall comprises feed openings so as to allow to feed fluid from the cooling fluid channel into the chamber volume. Moreover, the combustion chamber comprises means for forming a recirculation zone. The recirculation zone may be located near the flow entrance end of the chamber volume and/or near the inner combustor wall. The cooling channel is then divided into a first channel section surrounding the recirculation zone and comprising at least some of the feed openings and a second channel section surrounding the chamber volume outside the recirculation zone. The fuel supply is present in first channel section.

In this special embodiment the fuel supplied into the first channel section of the cooling fluid channel is not led to the burner but instead introduced directly into the chamber volume where the recirculation zone is present. By suitably locating the feed holes the fuel distribution through the feed holes into the outer recirculation zone stabilizes the combustion which allows to operate the combustion system with a leaner fuel-air mixture, i.e. a mixture that is closer to the extinction limit. The leaner mixture further reduces the NOx emissions. In addition, fuel distribution into the recirculation zone can enhance flame stability by anchoring the flame on the low velocity areas and reduces combustion dynamics, that are due to lean fuel-air mixtures.

In the inventive method of reducing combustion instability and/or emissions of a combustor system which comprises a combustion chamber and at least one burner connected to the combustion chamber the combustion chamber having a flow entrance by which the burner is connected to the combustion chamber, a flow exit through which combustion gases exit the combustion chamber, a chamber volume which extends between the flow entrance and flow exit, and an inner chamber wall separating a cooling fluid channel from the chamber volume, fuel is supplied to the cooling fluid in the cooling fluid channel. By supplying fuel into the cooling fluid channel the advantages already discussed with respect to the inventive combustor system are achieved.

The fuel may, in particular, be supplied to the cooling fluid near the flow exit and led by the cooling fluid channel to the burner in order to realize a regenerative cooling system. Furthermore, flowing all along the hot inner chamber wall leads to natural preheating. In addition, the longer way of the fuel to the burner as compared to fuel supplied directly to the burner can be used to reduce combustion dynamics as discussed above with respect to the inventive combustor system.

Alternatively, combustion in a recirculation zone located in the chamber volume may be stabilized by introducing the fuel-air mixture of the cooling fluid channel into the recirculation zone. By this measure the combustion in the recirculation zone can be stabilized and the flame can be anchored on low velocity areas, as discussed above with respect to the inventive combustor system.

For preventing ignition of the fuel air mixture in the cooling fluid channel the amount of fuel supplied to the cooling fluid is preferably so low that the resulting fuel air mixture is below flammability limit.

As already discussed above, in the inventive method, the combustion instability and/or NOx emissions can be reduced by controlling the fuel split between the at least one burner and the cooling fluid channel. In particular the fuel split may be controlled by individually controlling the amount of fuel supplied to the at least one burner and the cooling fluid channel, respectively.

### BRIEF DESCRIPTION OF THE DRAWINGS

Further features, properties and advantages of the present invention will be come clear from the following description of embodiments in conjunction with the accompanying drawings.

FIG. 1 shows a first embodiment of the inventive combustor system.

FIG. 2 shows a second embodiment of the inventive combustor system.

FIG. 3 shows the fuel supply system used in the inventive combustor system.

FIG. 4 schematically shows the control system for controlling the fuel split in the inventive combustor system.

### DETAILED DESCRIPTION OF INVENTION

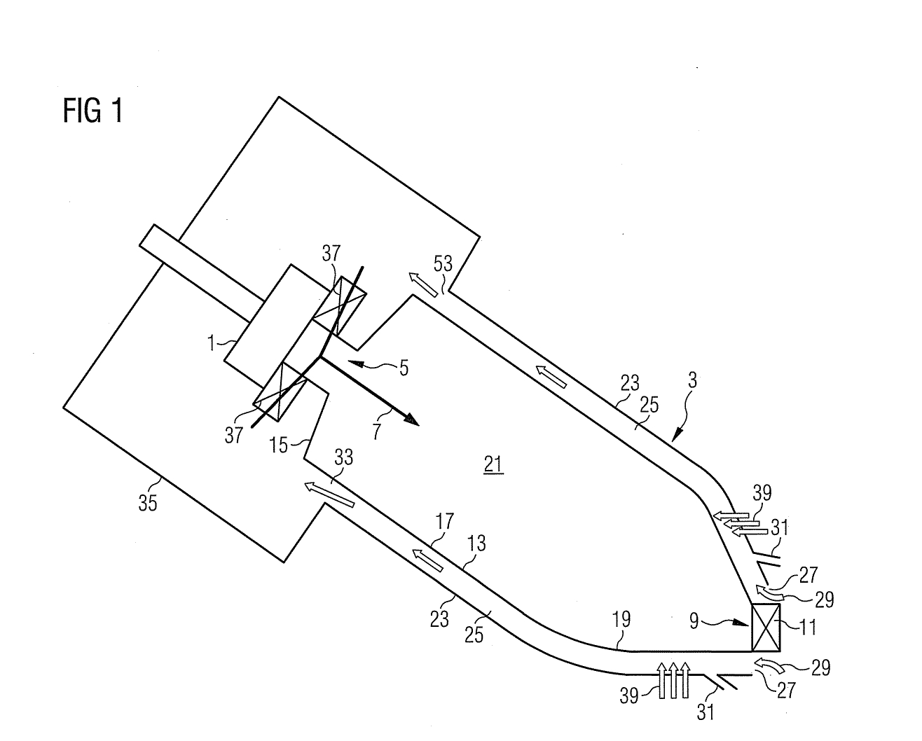

A first embodiment of the inventive combustor system is shown is FIG. 1. This embodiment is used in a gas turbine as one of a number of combustor systems distributed around the circumference of the gas turbine's rotor.

The combustion system comprises a burner 1 and a combustion chamber 3. The burner 1 is located at a flow entrance 5 of the combustion chamber 3 through which a fuel-air mixture is delivered into the combustion chamber 3 by the burner. The flow of the fuel-air mixture is indicated by arrow 7.

A flow exit 9 is located opposite to the flow entrance 5. The flow exit 9 leads to the nozzle guide vane 9 of a turbine. Combustion gases produced in the combustion chamber 3 leave the chamber through the flow exit towards the turbine.

The combustion chamber 3 comprises an inner chamber wall 13 which has a dome portion 15 over which the diameter of the combustion chamber 3 gradually increases, a cylindrical portion 17 in which of the diameter of the combustion chamber 3 is more or less constant and conical portion 19 over which the diameter of the combustion chamber 3 decreases towards the diameter of the flow exit 9. The inner chamber wall 13 delimits a chamber volume 21 that extends from the flow entrance 5 to the flow exit 9 and in which the combustion takes place.

The combustor system further comprises an outer chamber wall 23 which is spaced from the inner chamber wall 13 and the geometry of which follows the geometry of inner chamber wall over the cylindrical wall portions 17 and the conical wall portion 19. The space between the inner chamber wall 13 and the outer chamber wall 23 forms a flow channel 25 for a cooling fluid which, in the present embodiment, is air providing from the gas turbine's compressor. However, other cooling fluids which can be used for oxidizing fuel could be used as well. The flow channel 25 comprises one or more air inlet openings 27 through which the compressor air enters the flow channel 25 as indicated by the arrows 29.

Fuel supply lines 31 are present near the air inlet openings 27. Through the fuel supply lines 31, gaseous or liquid fuel is introduced into the compressor air in the flow channel 25. In case a liquid fuel is introduced the liquid fuel will be atomized before introducing it into the flow channel 25. However, preferably a gaseous fuel is supplied to compressor air in the flow channel 25. The fuel supplied to the compressor air flowing through the flow channel 25 mixes with the compressor air while it is guided along the inner chamber wall 13 towards one or more air exit openings 33 which are present at the location where the cylindrical wall portion 17 merges the dome portion 15.

A hood 35 surrounds the burner 1 and the dome portion 15 so that the fuel air mixture leaving the flow channel 25 through the one or more air exit opening 33 is discharged into the volume of the hood 35 from where it enters the burner 1 through a swirler arrangement 37. Additional fuel is introduced into the fuel-air mixture flowing through the swirler arrangement 37 so that a staged fuel supply is realized where the first fuel supply is formed by the fuel supply lines 31 leading to the flow chamber and the second fuel supply is formed by intrinsic fuel supply lines of the burner 1.

In the present embodiment, the combustor system is located in a pressure plenum into which compressor air is discharged. The compressor air enters the flow channel 25 through the one or more air inlet openings 27. In addition, the outer chamber wall 23 is, in the present embodiment, provided with holes which allow air from the pressure plenum to enter the flow channel 25 in a direction which is generally perpendicular to the flow direction through the flow channel. This air then forms jets which impinge onto the inner chamber wall 13 so as to realize impingement cooling of this wall. In addition, by such an impingement cooling a thorough mixing of fuel and air in the flow channel 25 is achieved. Impingement cooling is indicated in FIG. 1 by arrows 39. However although this arrows are only shown in a small part of the flow channel 25 impingement cooling holes may be present in every part of the outer chamber wall 23.

Due to the long way the fuel supplied through the fuel supply lines 31 into the compressor air has to travel along the hot the inner chamber wall 13 until it reaches the air exit openings 33 a preheating of the fuel-air mixture takes place before the fuel-air mixture enters the burner 1 through the swirler arrangement 37. The preheating usually leads to an increased combustion efficiency.

Please note that although the thorough mixing of fuel and air in flow channel 25 is achieved through turbulences generated by the impingement cooling jets other means for generating turbulences, and thus thoroughly mixing fuel and air, could be used alternatively or additionally. Other possible features or means are, for example, fins, turbulators and flow contraction and expansion means in the compressor air inlet and exit openings 27, 33. However independent of the means for generating turbulence, turbulences in the flow channel 25 promote mixing of fuel and air which is beneficial for low NOx emissions.

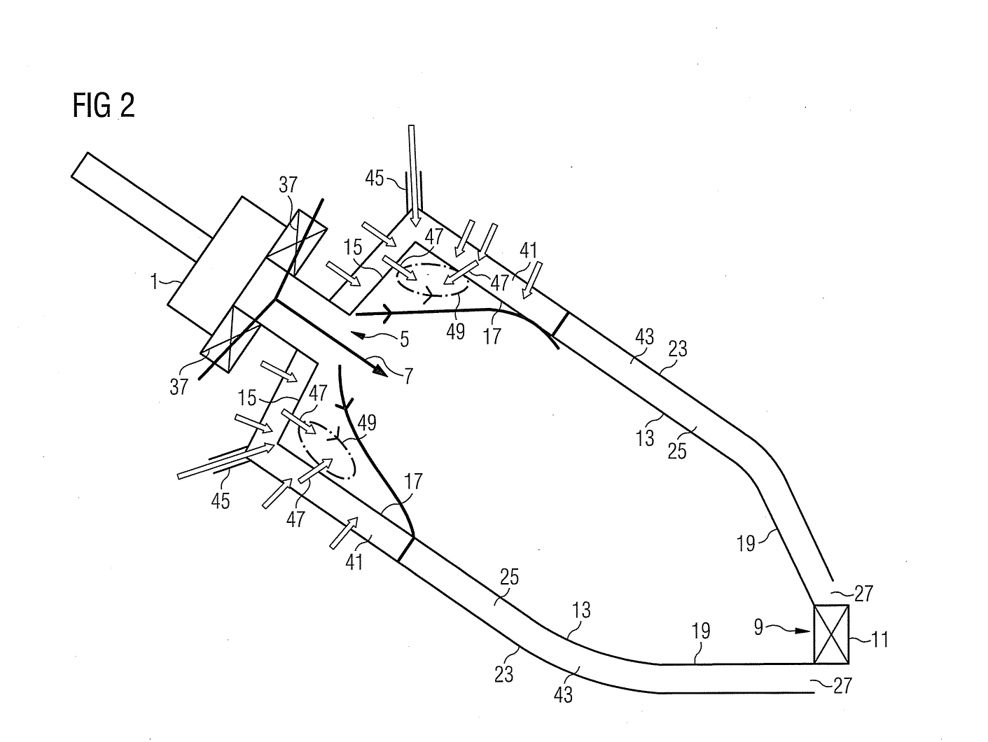

A second embodiment of the inventive combustor system is shown in FIG. 2. In many parts the second embodiment is identical to the first embodiment. Therefore, only those parts which differ from the first embodiment will be explained. Those parts which correspond to parts in the first embodiment are denominated with the same reference numerals as in the first embodiment and will not be explained again.

The second embodiment differs from the first embodiment in that no hood is present. In addition, the outer chamber wall 23 completely surrounds the inner chamber wall 13.

The flow channel 25 present between the inner chamber wall 13 and the outer chamber wall 23 is subdivided into a first channel section 21 which extends over the dome portion 15 and part of the cylindrical portion 17 of the inner chamber wall 13 and a second channel section 43 which extends over the other part the cylindrical wall portion 17 and the conical wall portion 19.

Cooling air may enter the second channel section 43 through optional compressor air inlet openings 27 like in the first embodiment. However, this compressor air is neither mixed with fuel nor led to the swirler arrangement 37 of the burner 1. Instead it is introduced into the combustor volume 21 through effusion holes in the inner combustor wall 13. In addition, holes for allowing impingement cooling may be present in the outer combustor wall 23 in the second channel region 43.

The first channel section of the flow channel 25 is closed at its ends. However, openings for allowing impingement cooling of the inner chamber wall 13 are present in the first channel section 41. In addition, fuel supply lines 45 for supplying fuel into the first channel section 41 are located where the dome portion 15 merges the cylindrical wall portion 17. Fuel introduced into the impingement cooling air in the first channel section 41 by this supply lines 45 will be thoroughly mixed with the air due to turbulences generated by the impingement cooling jets.

Furthermore, effusion hole are present in the inner chamber wall 13 of the first channel region 41 in the dome portion and/or the cylindrical wall portion 17. Hence, the fuel-air mixture developed in the first channel section 41 enters the chamber volume 21 through the dome portion 15 and/or the cylindrical wall portion 17, as indicated by arrows 47. In this section of the chamber volume 21 recirculation zones 49 are present for supporting combustion. Combustion in the recirculation zones is stabilized by the introduced fuel air mixture. This stabilization allows for operating the combustion system leaner and closer to extinction limit, which in turn reduces NOx emissions. In addition, when the combustor system is operated close to lean extinction limits it will experience dynamics if the flame is not properly anchored. In the present embodiment, the fuel-air mixture introduced into the outer recirculation zone can enhance flames stability by anchoring the flame on the low velocity areas and hence reduces the dynamics caused by operation close to the lean extinction limit.

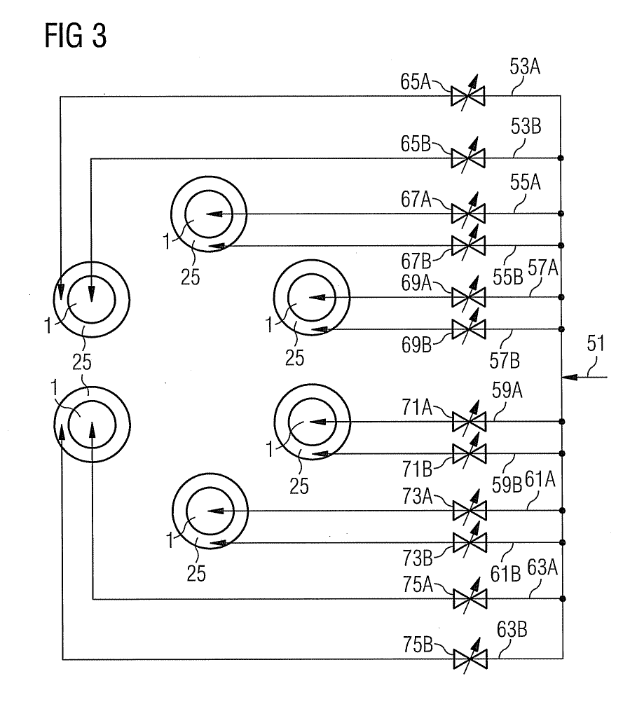

A fuel supply distribution scheme to the burners and the flow channel 25 (first embodiment) or the first channel section 41 (second embodiment) of six combustor systems arranged around the circumference of a gas turbine rotor (not shown) is shown in FIG. 3. A common fuel supply line 51 leads to branch supply lines 53A, 53B, 55A, 55B, . . . , 63A, 63B. Each branch supply line 53B, 55A, 55B, . . . , 63A, 63B is equipped with a control valve 65A, 65B, . . . , 75A, 75B. While all branch supply lines denominated with the suffix A lead to a first fuel stage, i.e. the burner of one of six combustor systems, each supply line denominated with the suffix B leads to a second fuel stage of the combustor systems formed by the flow channel 25 in case of the first embodiment or the first channel section 41 in case of the second embodiment. The amount of fuel supplied through each branch supply line can be individually set by the control valves 65A, 65B, . . . , 75A, 75B.

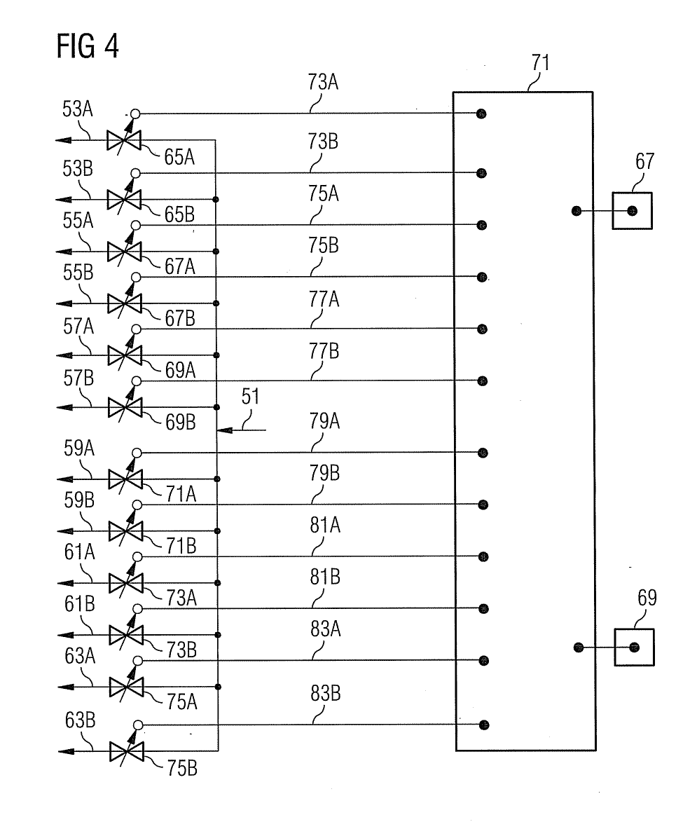

A control system for controlling the amount of fuel supplied by each of the branch supply channels 53A, 53B, . . . , 63A, 63B is schematically shown in FIG. 4. The control system comprises an acceleration sensor 67 which is located at the combustion chamber wall in order to measure accelerations of combustion chamber wall which indicate combustion dynamics. Instead of a acceleration sensor a pressure sensor measuring the pressure inside the combustion chamber 3 could be used as well. In addition, a NOx sensor 69 is located in the exhaust diffusor of the gas turbine. This sensor measures the NOx fraction in the exhaust gas. Both sensors 67, 69 are connected to a controller 71 which receives the signals from the sensors which represent the combustion dynamics and the NOx fraction. The controller then determines a fuel split to the first and second fuel stages of the combustor systems and outputs corresponding individual control signals to the control valves 65A, 65B, . . . , 75A, 75B through control lines 73A, 73B, . . . , 83A, 83B. The individual control signals are representative for valve settings that allow a certain amount of fuel to pass per time unit. Hence, the control signals determine the fuel splits of each the combustor systems. By appropriately setting the fuel split to the first and second fuel stages of the combustor systems the combustion dynamics and the NOx emissions can be influenced. Hence, the described control system establishes a feedback loop which allows for adaptively reducing combustion dynamics and NOx emissions.

The control system is based on the fact that combustion instability is amplified when combustion dynamics pressure waves are in phase with fuel injection fluctuations. The time for fuel to travel from the injection location of the respective fuel stage to the flame is different for the fuel injected in the burner and the fuel injected in the flow channel 25 or the first channel section 41. This time difference allows for applying an optimized fuel split to the different stages, in order to break up the combustion dynamics amplifying loop so that combustion instability can be avoided.

In particular, the control system gives a very efficient measure in optimizing turbine emissions and combustion dynamics as the overall fuel-air premixing and acoustic time lag can be controlled by use of the proposed staging. Fuel distribution to burner and to the flow channel (first embodiment) or the outer recirculation zone (second embodiment) via a combustor cooling channel system can be actively controlled based on the combustion dynamics and emissions measurement to achieve low dynamics and low NOx emissions for the complete turbine load range.

1.-15. (canceled)

16. A combustor system, comprising:
a combustion chamber, the combustion chamber comprising:
a flow entrance connecting the burner to the combustion chamber,
a flow exit through which combustion gases exit the combustion chamber,
a chamber volume extending between the flow entrance and the flow exit,
an inner chamber wall separating a cooling fluid channel from the chamber volume, and
a fuel supply line leading into the cooling fluid channel to supply a fuel to a cooling fluid; and
a burner connected to the combustion chamber.

17. The combustor system as claimed in claim 16, wherein a plurality of turbulence generating features are located in the cooling channel.

18. The combustor system as claimed in claim 17, wherein the plurality of turbulence generating features include a plurality of fins, and/or a plurality of turbulators, and/or a flow contraction and expansion device.

19. The combustor system as claimed in claim 17,
wherein the plurality of turbulence generating features further include an outer chamber wall surrounding the inner chamber wall, and
wherein the outer chamber wall comprises a plurality of through holes connecting the cooling fluid channel to a pressure plenum with a cooling fluid such that the cooling fluid impinges onto the inner chamber wall.

20. The combustor system as claimed in claim 16, further comprising a fuel split control system to control a distribution of fuel to the burner and to the cooling fluid channel.

21. The combustor system as claimed in claim 20,
wherein the fuel split control system includes a plurality of individual fuel supply lines for the burner and for the cooling fluid channel, and
wherein each individual fuel supply line is equipped with a control valve.

22. The combustor system as claimed in claim 20,
wherein the fuel split control system includes a combustion dynamics sensor and/or an NOx sensor, and a first controller connected to the combustion dynamics sensor and/or the NOx sensor,
wherein the first controller receives a plurality of sensor signals representing measured combustion dynamics and/or measured NOx amounts, and
wherein the first controller derives a fuel split signal representing the fuel split to be set by the fuel split control system on the basis of the measured combustion dynamics and/or measured NOx amount.

23. The combustor system as claimed in claim 16, further comprising the first controller or a second controller controlling a fuel supply to the cooling fluid in the cooling fluid channel such that an amount of fuel supplied to the cooling fluid is low enough so that a resulting fuel-air mixture is below a flammability point.

24. The combustor system as claimed in claim 16,
wherein the fuel supply line is located near the flow exit, and
wherein the cooling fluid channel directs the cooling fluid to the burner.

25. The combustor system as claimed in claims 16,
wherein the inner chamber wall includes a plurality of feed openings that feeds fluid from the cooling fluid channel into the chamber volume,
wherein the combustion chamber includes a formation of a recirculation zone,
wherein the cooling channel is divided into a first channel section surrounding the recirculation zone comprising at least some of the feed openings and a second channel section surrounding the chamber volume outside the recirculation zone, and
wherein the fuel supply line is located in the first channel section.

26. A method for reducing combustion instability and/or emissions of a combustor system, comprising:
providing a combustion chamber and a burner connected to the combustion chamber, the combustion chamber comprising:
a flow entrance connecting the burner to the combustion chamber,
a flow exit through which combustion gases exit the combustion chamber,
a chamber volume extending between the flow entrance and the flow exit, and
an inner chamber wall separating a cooling fluid channel from the chamber volume; and
supplying a fuel to a cooling fluid in the cooling fluid channel.

27. The method as claimed in claim 26, wherein the fuel is supplied to the cooling fluid near the flow exit and flows through the cooling fluid channel to the burner.

28. The method as claimed in claim 26, wherein a recirculation zone is located in the chamber volume and a fuel-air mixture of the cooling fluid channel is introduced into the recirculation zone.

29. The method as claimed in claim 26, wherein an amount of the fuel supplied to the cooling fluid is low enough so that the resulting fuel-air mixture is below a flammability point.

30. The method as claimed in claim 26, wherein combustion instability and/or NOx emissions is/are reduced by controlling a fuel split between the burner and the cooling fluid channel.

31. The method as claimed in claim 30, wherein the fuel split is controlled by individually controlling the amount of fuel supplied to the burner and to the cooling fluid channel.

32. The method as claimed in claim 31, wherein in order to control the amount of fuel supplied to the burner and the cooling fluid channel, a plurality of control valves are used.

33. The method as claimed in claim 26, wherein a plurality of turbulence generating features are located in the cooling channel.

34. The method as claimed in claim 26, wherein the plurality of turbulence generating features include a plurality of fins, and/or a plurality of turbulators, and/or a flow contraction and expansion device.

35. The method as claimed in claim 26,
wherein the plurality of turbulence generating features further include an outer chamber wall surrounding the inner chamber wall, and
wherein the outer chamber wall comprises a plurality of through holes connecting the cooling fluid channel to a pressure plenum with a cooling fluid such that the cooling fluid impinges onto the inner chamber wall.
